(19) United States
(12) Patent Application Publication
(10) Pub. No.: US 2025/0033502 A1
(43) Pub. Date: Jan. 30, 2025

(54) EV CHARGING DOCK SYSTEM

(71) Applicant: EVJAM LLC, Minneapolis, MN (US)

(72) Inventors: Steven DICKE, Minneapolis, MN (US); Gregg KROMREY, Hudson, WI (US)

(73) Assignee: EVJAM LLC, Minneapolis, MN (US)

(21) Appl. No.: 18/784,870

(22) Filed: Jul. 25, 2024

Related U.S. Application Data
(60) Provisional application No. 63/528,863, filed on Jul. 25, 2023.

(51) Int. Cl. B60L 53/302; B63B 35/44; H01M 10/613; H01M 10/625; H01M 10/6554; H01M 10/6567

(52) U.S. Cl. CPC B60L 53/302; B63B 35/44; H01M 10/613; H01M 10/625; H01M 10/6554; H01M 10/6567; B60L 2200/32; B63B 2035/4453; H01M 2220/20

(57) ABSTRACT

One or more examples provide an electric vehicle charging system and method for charging an electric watercraft. In one example, the charging system is a charging dock system for charging an electric vehicle including an electric watercraft. The charging dock system can also be used as a power station for powering devices associated with a dock area such as an on the water entertainment area.

### CROSS REFERENCE TO RELATED APPLICATION

This Non-Provisional Patent Application claims the benefit of the filing date of U.S. Provisional Patent Application Ser. No. 63/528,863, filed Jul. 25, 2023 and which is herein incorporated by reference.

### TECHNICAL FIELD

The present disclosure relates generally to examples of electric vehicles and to devices for use with an electric vehicle, including electric watercraft charging systems and devices.

### BACKGROUND

Electric vehicles and electric vehicle devices provide quiet, clean, and efficient powertrains for moving from place to place or for getting work done.

For these and other reasons, there is a need for the present invention.

### SUMMARY

The present disclosure provides one or more examples of an electric vehicle and systems and/or devices for use with an electric vehicle. In one or more examples, the system is an electric vehicle charging system and/or charging device suitable for use with an electric watercraft.

In one example, the charging system is a charging dock system for charging an electric vehicle including an electric watercraft. The charging dock system can also be used as a power station. In one example, the charging dock system is used as a power station for an on the water entertainment area.

Additional and/or alternative features and aspects of examples of the present technology will become apparent from the following description and the accompanying drawings.

### BRIEF DESCRIPTION OF THE DRAWINGS

The Figures generally illustrate one or more examples of an electric vehicle and/or devices for use with an electric vehicle such as electric vehicle charging systems and devices, including an electric vehicle charging dock system.

FIG. 1 is a diagram generally illustrating an EV charging dock system, according to examples of the present disclosure.

FIG. 2 is a diagram illustrating an EV charging dock system, according to examples of the present disclosure.

FIG. 3a is a diagram illustrating a charging panel for use with an EV charging dock system, according to examples of the present disclosure.

FIG. 3b is a section view illustrating an example of a charging panel for use with an EV charging dock system, according to examples of the present disclosure.

FIG. 3c is a section view illustrating an example of a charging panel for use with an EV charging dock system, according to examples of the present disclosure.

FIG. 3d is a diagram illustrating an example of a charging panel for use with an EV charging dock system, according to examples of the present disclosure.

FIG. 4a is a diagram illustrating a partial view of a coupling system between two dock charging panels in an EV charging dock system, according to examples of the present disclosure.

FIG. 4b is a diagram illustrating a partial view of a coupling system between two dock charging panels in an EV charging dock system, according to examples of the present disclosure.

FIG. 4c is a diagram illustrating a partial view of a coupling system between two dock charging panels in an EV charging dock system, according to examples of the present disclosure.

FIG. 4d is a diagram illustrating a partial view of an alternative coupling system between two dock charging panels in an EV charging dock system, according to examples of the present disclosure.

FIG. 4e is a diagram illustrating a partial view of a coupling system between two dock charging panels in an EV charging dock system, according to examples of the present disclosure.

FIG. 4f is a diagram illustrating a partial view of a coupling system between two dock charging panels in an EV charging dock system, according to examples of the present disclosure.

FIG. 4g is a diagram illustrating a partial view of a coupling system between two dock charging panels in an EV charging dock system, according to examples of the present disclosure.

FIG. 4h is a diagram illustrating a partial view of a coupling system between two dock charging panels in an EV charging dock system, according to examples of the present disclosure.

FIG. 5 is a diagram illustrating a partial view of a coupling system between two dock charging panels in an EV charging dock system, according to examples of the present disclosure.

FIG. 6 is a block diagram illustrating one example configuration of an EV charging dock system, according to examples of the present disclosure.

FIG. 7 is a diagram illustrating one example configuration of an EV charging dock system, according to examples of the present disclosure.

FIG. 8 is a diagram illustrating one example configuration of an EV charging dock system, according to examples of the present disclosure.

FIG. 9a is a block diagram illustrating an EV charging dock system, according to examples of the present disclosure.

FIG. 9b is a block diagram illustrating an EV charging dock system, according to examples of the present disclosure.

FIG. 9c is a block diagram illustrating a primary power system for an EV charging dock system, according to examples of the present disclosure.

FIG. 10 is a diagram illustrating an EV charging dock system, where the EV charging system is a floating dock charging system, according to examples of the present disclosure.

FIG. 11a is a diagram illustrating a charging dock unit for use with an EV charging dock system, according to examples of the present disclosure.

FIG. 11b is a diagram illustrating a charging dock unit for use with an EV charging dock system, according to examples of the present disclosure.

FIG. 11c is a diagram illustrating a charging dock unit for use with an EV charging dock system, according to examples of the present disclosure.

FIG. 12 is a diagram illustrating a charging dock unit for use with an EV charging dock system, according to examples of the present disclosure.

FIG. 13 is a diagram illustrating a charging hub for use with an EV charging dock system, according to examples of the present disclosure.

FIG. 14 is a diagram illustrating a charging hub for use with an EV charging dock system, according to examples of the present disclosure.

FIG. 15 is a diagram illustrating dock charging system configurations for use with an EV charging dock system, according to examples of the present disclosure.

FIG. 16 is a diagram illustrating dock charging system configurations for use with an EV charging dock system, according to examples of the present disclosure.

FIG. 17 is a diagram illustrating dock charging system configurations for use with an EV charging dock system, according to examples of the present disclosure.

FIG. 18 is a diagram illustrating an on the water power station, including an EV charging dock system, according to examples of the present disclosure.

FIG. 19 is a diagram illustrating an on the water power station configured as a bar and suitable for use with an EV charging dock system, according to examples of the present disclosure.

FIG. 20 is a block diagram illustrating one example of the power station of FIG. 19.

FIG. 21 is a diagram illustrating an on the water power station configured as a swim raft, suitable for use as an EV charging system, according to examples of the present disclosure.

FIG. 22 is a diagram illustrating a side view of the on the water power station configured as a swim raft of FIG. 21, according to examples of the present disclosure.

FIG. 23 is a block diagram illustrating an on the water power station configured as a swim raft, according to examples of the present disclosure.

FIG. 24 is a diagram illustrating an EV charging dock system including a cooling system, according to examples of the present disclosure.

FIG. 25 is a diagram illustrating a side view of an EV charging dock system including a cooling system, according to examples of the present disclosure.

FIG. 26a is a diagram illustrating an EV charging dock cooling system, according to examples of the present disclosure.

FIG. 26b is a diagram illustrating an EV charging dock cooling system, according to examples of the present disclosure.

FIG. 26c is a diagram illustrating an EV charging dock cooling system, according to examples of the present disclosure.

FIG. 26d is a diagram illustrating an EV charging dock cooling system, according to examples of the present disclosure.

FIG. 26e is a diagram illustrating an EV charging dock cooling system, according to examples of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

Electric vehicles (EVs), such as automobiles (e.g., cars and trucks), autonomous vehicles, snowmobiles, electric watercraft, all-terrain vehicles (ATVs), side-by-side vehicles (SSVs), and electric bikes, for example, offer a quiet, clean, and more environmentally friendly option to gas-powered vehicles. Electric vehicles have electric powertrains which typically include a battery system, one or more electrical motors, each with a corresponding electronic power inverter (sometimes referred to as a motor controller), and various auxiliary systems (e.g., cooling systems).

### Electric Vehicle Charging Dock System

The present disclosure provides one or more examples of an electric vehicle charging dock. In one application, the system is suitable for use in both floating dock and suspended dock applications. The present charging system may be used to charge electric vehicles such as one or more electric watercraft. Additionally, the present charging system may be used as an on the water power station. The charging system can include its own battery packs for charging of electric vehicles or for powering electrical devices local to the dock. For example, the dock charging system can be used as a power station for an on the water entertainment area.

Operation of the charging dock system may be done either local to the charging dock or remotely via a computer, ev control system, charging station control system, or a user control application located on a smart device (e.g., via a phone).

One or more examples and features of an EV Charging Dock System are detailed herein and illustrated in the Figures. A Dock including an EV Charging Dock System can include a combination of one or more of the following features illustrated in this specification.

Suspended Charging Dock. The EV charging system can be configured as a suspended charging dock with dock charging panels. The dock charging panels are structurally supported above the water surface. The charging dock includes one or more dock charging panels.

Multiple dock charging panels can be structurally and electrically coupled together. Each dock charging panel can include one or more dock smart system/sensors. A smart charging hub can be located at the end of the charging dock or along the charging dock for charging electric vehicles such as an electric watercraft. The charging dock system can be used in one or more other modes of operation such as a power station.

Dock Charging Panel. Each dock charging panel can include a charging battery pack. Each dock charging panel can include a charging wireway. The charging wireway can be formed integral the charging panel.

One or more dock charging panels can include both a charging battery pack and a charging wireway. In one example, the charging battery pack can be positioned inside or on the underside of a charging dock panel. The charging panel can protect a battery pack from getting wet, or can allow the battery pack to get wet. The dock charging panels can be removable dock panels as part of a dock system, such that they can be interchangeably removed from the dock frame.

Charging batteries that make up a battery pack can be located at desired locations of the charging panel. For example, a charging battery can be located along an outside edge of a dock charging panel or near the center of a panel.

The dock charging panel can include drainage indents or openings in the surface of the panel (e.g., along the center of a panel). The dock charging panels can be made of a molded polymeric material or other suitable material. A charging wireway can be internally molded or constructed within the charging panel. A charging wireway can be formed in a panel extension.

Charging Panel Connections. The electrical connection between charging panels can be a flexible connection to allow for individual movement between panels. In one example, the charging panel connection includes a charging jumper between adjacent charging panels.

A charging jumper can include a flexible cable coupled between charging panels. In one example, a charging jumper is quick coupled to a charging panel. In one example, a charging jumper is positioned underneath or along side of the charging panels. In one example, the charging panel jumpers include a watertight/locking connection at each panel.

In one example, the connection is a quick connect coupled connection. In another example, the charging jumper includes a shaped charging jumper (e.g., a generally u-shaped charging jumper) that is flex connected to adjacent panels at each end. In another example, there is a flex member that connects adjacent charging panels. Flexible electrical connections/wireways are located in the flex members.

Charging Dock Examples. In one example, a charging dock can include charging panels where each panel includes a charging battery panel, or where each charging panel includes a wireway. In one example, a charging dock includes charging panels that include a charging battery panel, a charging wireway, or both.

In one example, the charging dock includes one or more charging panels. The charging panels are electrically coupled together to form the charging dock system. A master charging station or charging power feed is positioned near the charging dock. The master charging station or charging power feed is electrically coupled to the charging dock. The charging station or charging power feed can be plugged into the charging dock for feeding power through the charging dock or for charging the charging panels.

One or more solar panels can be positioned on the charging dock as a primary or secondary power source to power the charging dock. The charging panels can be positioned on a surface of the dock, above the surface of the dock, or within the surface of the dock (e.g., a dock panel having a solar panel).

A charging hub can be located at the end of the charging dock or along the charging dock for charging an electric watercraft.

Sensors can be positioned at one or more locations along the charging dock for activating one or more dock systems upon sensing a desired dock component. For example, the sensors can be utilized to sense activity on the dock surface or the presence of an electric vehicle near the dock or dock charging hub. Sensors can also be utilized for other purposes, such as for shutting down the dock system upon detection of other elements such as an incoming storm system, rain, lightning or thunder.

Charging Dock Power System/Power Station. In one example, the charging dock includes a Charging Dock Power System. The power system can include a primary power system and/or a secondary power system.

In one example, the power system includes a battery pack, a DC/DC converter, and an auxiliary battery. The battery pack provides charging outputs and can be coupled to the charging hub. The DC/DC converter charges the auxiliary battery at a desired level (e.g., 120 volts), and can be used as a power supply for auxiliary devices (e.g., dock lights, dock sensors, tiki bar systems, coolers, sound systems, etc.). The power system can be coupled to one or more solar panels via a regulator as a primary or secondary power charger.

Charging Floating Dock System. In one or more examples, the charging dock system is part of a charging floating dock system. The charging floating dock system can be similar to the charging system previously discussed herein.

In one example, the floating dock charging system includes floating dock units. The floating dock units are movably coupled together to form a floating dock that is a floating dock charging system. Each floating dock can have a battery pack, a wireway, or one or more combinations of a battery pack and a wireway.

In one example, each floating dock unit includes a float and a floating dock panel. The floating dock unit may also include a transition piece. Charging jumpers can be used to electrically connect floating dock units, and battery packs and wireways within those floating dock units. The charging jumpers/flexible electrical connections can be located in a flex member that connects adjacent floating dock units.

Master Station. Receives incoming charging power feed and provides a distributed power feed to one or more charging hubs located on a charging dock.

Charging Hub and Charging Cable. Positioned at a desired location on the charging dock for charging an electric watercraft. Can be addressable/numbered, and tracked via a GPS system.

Includes a charging cable with plug for coupling to an electric vehicle requesting a charge. Includes a plug (e.g., a lockable plug) system for coupling to the charging outlet. Includes a charging plug for coupling the charging system to an electric vehicle charging port. May include an adapter suitable for use with the charging plug to aid in adapting to specific charging configurations. The charging cable can be portable and configured for use with a specific charging electric watercraft or other devices or systems located on the dock.

Dynamic Charging/Load Management/Balancing System. Can include a load management/balancing system to optimize charging. Load balancing system factors can include: number of devices requesting a charge, type of vehicle, desired charging speed, desired charging type, charging supply power available, etc.

Charging Dock System. Can be part of a single dock that extends out over the water. Can be part of a multi-dock system that includes multiple charging hubs and/or charging dock power devices.

The charging dock system can operate as a power station for powering electrical devices (AC or DC) local to the dock such as an on the water entertainment area, dock lights, sound system or bar area.

In one example, the charging dock system can include one or more of the follow charging dock set-ups—a watercraft docking area with a charging hub, a charging hub for boat-up watercraft, personal watercraft docking and charging areas, seating and entertainment areas, a bar area such as a tiki bar.

A charging dock entertainment area can include power for lights, music, and a fully functional bar area such as a tiki bar.

A tiki bar, for example, can include a charging hub/smart charging station, power outlets, a battery pack, solar panels, and most anything else needed for a fully functional entertainment/bar area.

The charging dock system can be used as part of most any fully functional dock/floating dock system. In one example, the charging dock is utilized as a swim raft that can also include an electric watercraft charging station. In one example, the charging station is solar powered, and includes a solar powered battery pack located inside the floating swim raft.

Charging Dock Cooling System. The charging dock can include a cooling system for one or more of the dock sections. For example, the cooling system can be activated during use of a floating dock battery pack to optimize power delivery from the battery pack.

In one example, the cooling system utilizes raw water for cooling. In one example, the cooling system utilizes a combination raw water/closed loop clean water system with a heat exchanger. In one example, the cooling system utilizes entirely clean water or coolant as part of a closed loop system. One or more cooling plate configurations can be used as part of optimizing the cooling system using available raw water with the heat exchanger or passing through the battery pack.

One or more examples and features of the charging dock system are detailed herein and illustrated in the Figures.

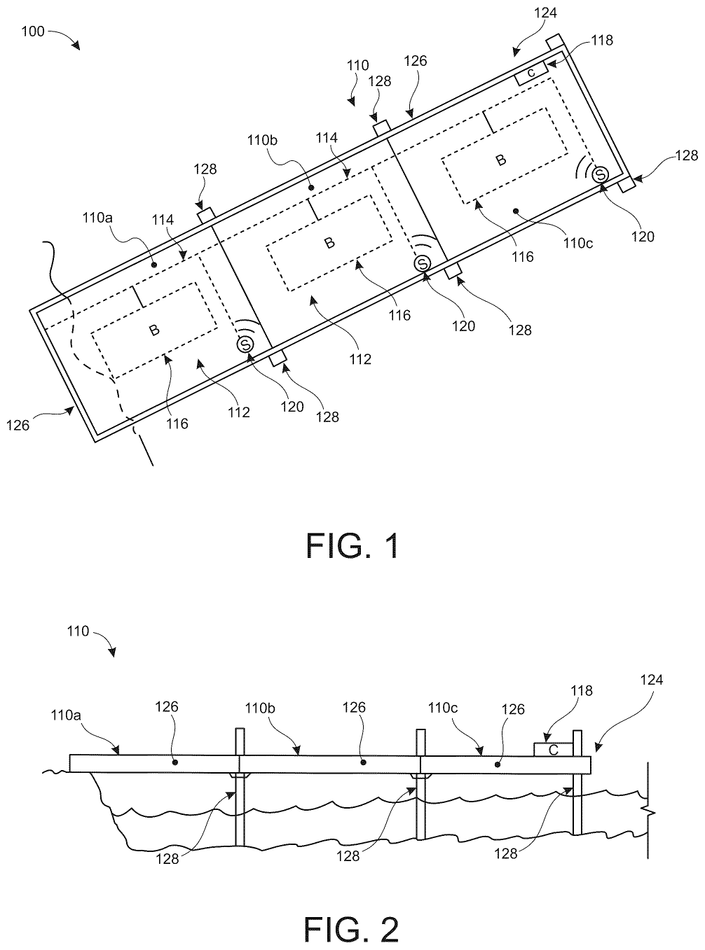

FIG. 1 is a diagram generally illustrating an EV charging dock system generally at 100, according to examples of the present disclosure. The charging dock system 100 provides on the water charging of electric watercraft, and operates as an on the water power station for other electric devices.

The charging dock system 100 can be configured as a suspended charging dock or floating charging dock. In the example of FIG. 1, a suspended charging dock is illustrated.

In one example, the charging dock system 100 includes dock charging panels 110, illustrated as first charging panel 110a, second charging panel 110b and third charging panel 110c. Dock charging panels 110 include a dock charging device 112 that aids in charging an electric watercraft. Example dock charging devices 112 include a charging wireway 114 and/or a battery pack 116. Battery pack 116 can include one battery or multiple batteries to form the battery pack. The charging dock system includes charging hub 118. Charging hub 118 is a charging station for an electric watercraft needing a charge. In one example, each charging panel 110a, 110b, 110c includes a battery pack 116 (as illustrated). It may be desirable for every charging panel to include a battery pack, allowing for smaller and slimmer batteries to be integrated into each charging panel. In other examples, less than all of the charging panels 110 include a battery or battery pack. In one example, only the charging panel 110a includes a battery pack.

In one example, the battery pack is made of one or more slim panel batteries. In one example, the panel batteries are lithium ion based panel batteries. Multiple battery packs from multiple charging panels located in adjacent dock sections can be coupled together to form one large battery pack. In operation, the charging panels easily fit inside a dock frame similar to existing dock wooden panels. The multiple charging panels operate as a dock surface similar to wooden panels, but also include charging devices such as charging wireways and battery packs. This allows for an on the water charging station without the need for additional dock structures.

Charging hub 118 can be a smart charging hub, and can include a charging port, a controller, and an on-board battery. The charging hub 118 communicates with other charging dock system devices, such as a remote control system or master control system (not shown), charging applications (e.g., such as through a computer, smart phone, or other smart device), and charging dock system sensors or detectors. In one example, the charging panel 110 includes sensor 120. Sensor 120 provides feedback information about the charging environments to charging hub 118. In one example, sensor 120 is a motion detector. For example, upon detection of extreme movement on a charging panel 110a, 110b or 110c, the sensor 120 can notify charging hub 118 to interrupt charging until the extreme movement alarm has cleared. In other examples, the sensor 120 can provide other sensed notifications, such as temperature, moisture (e.g., rain), etc. Sensor 120 can be hardwired to charging hub 118 via wireway 114, or can wirelessly communicate with charging hub 118.

Reference is also made to FIG. 2 which is a diagram further illustrating EV charging dock system 110, according to examples of the present disclosure. Charging dock system 100 includes a support structure 124. In one example, the charging dock system 100 is a suspended charging dock and the support structure 124 includes a dock frame 126 (e.g., a metallic or nonmetallic frame) coupled to support posts 128. Each charging panel 110a, 110b, 110c is removably positioned within the dock frame 126.

Each charging panel 110a, 110b, 110c can include one or more sensors 120. Charging hub 118 is coupled to a top surface of charging panel 110c. Charging hub 118 can be located or positioned at any desirable location on charging dock system 100. Additionally, charging dock system 100 can include multiple charging hubs positioned at different locations along the charging dock system.

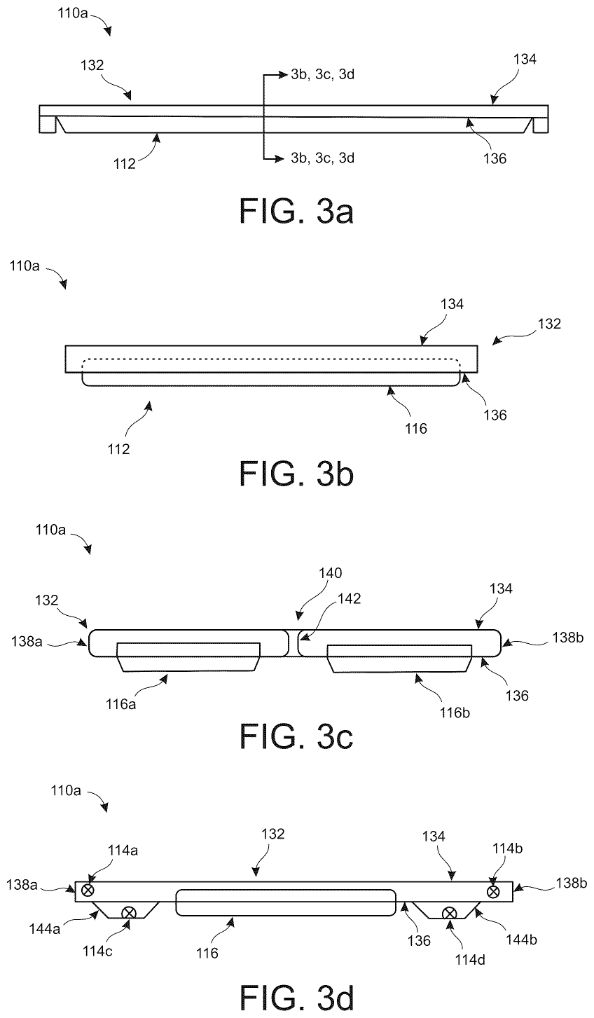

FIG. 3a is a diagram illustrating a charging panel for use with an EV charging dock system, according to examples of the present disclosure. In FIG. 3a, a side view of charging panel 110a is illustrated as an example. Charging panel 110a is generally rectangular shaped and includes a panel body 132. The panel body 132 is generally rectangular shaped and includes a top side 134 and a bottom side 136. Charging device 112 is integrated into the panel body 132. In one example illustrated, the charging device 112 extends from the bottom side 136 of the panel body 132. When charging panel 100a is positioned in a dock system, bottom side 136 faces the water and the charging device 112 is not viewable from the topside 134.

FIG. 3b, FIG. 3c, and FIG. 3d are section views of charging panel 110a, illustrating alternative embodiments of the charging panel.

Battery pack 116 is integrated into the panel body 132. In one example illustrated, the battery pack 116 extends from the bottom side 136 of the panel body 132. When charging panel 100a is positioned in a dock system, the battery pack 116 is not viewable from the panel body 132 top side 134.

FIG. 3b is a section view illustrating an example of charging panel 110a for use with an EV charging dock system. In this example, the charging device 112 includes battery pack 116. The battery pack 116 is integrated into the panel body 132. In one example illustrated, the battery pack 116 is a single rectangular shaped battery pack and extends from the bottom side 136 of the panel body 132. When charging panel 100a is positioned in a dock system, the battery pack 116 is not viewable from the panel body 132 top side 134.

FIG. 3c is a section view illustrating an example of charging panel 110a for use with an EV charging dock system. In this example, the charging device 112 includes multiple battery packs indicated as battery pack 116a and battery pack 116b. Each battery pack 116a, 116b is generally rectangular shaped and respectively extend along each side edge 138 of panel body 132. A channel 140 is located in the top side 134 (i.e., top surface) and extends longitudinally along the center of the panel body 132. The channel 140 is centered between the first battery pack 116a and the second battery pack 116b. Vias or vertical openings 142 are located along the channel 140 to aid in removing water from the top side 134 or the charging panel 110a.

Battery pack 116a and battery pack 116b are integrated into the panel body 132. The battery pack 116a and battery pack 116b extend from the bottom side 136, and are not viewable from top side 134. In other examples, both battery pack 116a and battery pack 116b are totally enclosed within the panel body 132.

FIG. 3d is a section view illustrating an example of charging panel 110a for use with an EV charging dock system. In this example, the charging device 112 includes multiple wireways, indicated as wireway 114a and wireway 114b. Wireway 114a extends longitudinally along side edge 138a, and wireway 114b extends longitudinally along side edge 138b. Each wireway 138a, 138b electrically couple to an adjacent charging panel (e.g., using a charging jumper or other flexible coupling device), for example, charging panel 110b. In one example, the wireways extend from a master charging station, through the charging panels 110, to one or more charging hubs such as charging hub 118.

Alternatively or additionally, charging panel 110a can panel extension 144a and panel extension 144b that extend from panel body 132. The panel extension 144a extends from bottom side 136 along side edge 138a. The panel extension 144b extends from bottom side 136 along side edge 138b. Wireway 114c is located within panel extension 144a and wireway extension 114d is located within panel extension 144b. Battery pack 116 extends from bottom side 136 of charging panel 110a, and is at least partially located in charging panel 110a. In other examples, battery pack 116 is entirely enclosed within panel body 132. The battery pack 116 electrically couples to the charging hub 118 via wireways 114a, 114b.

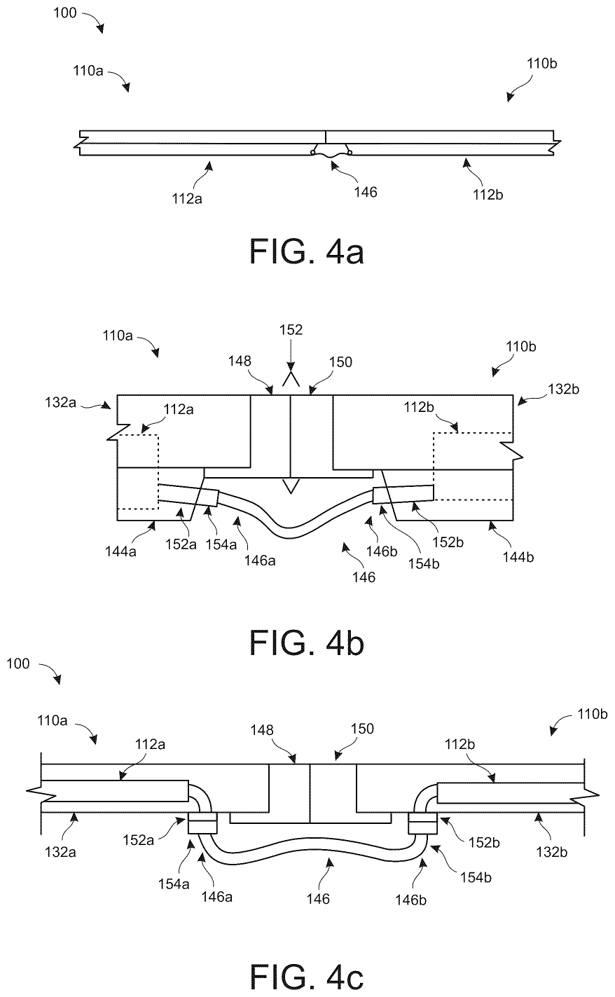

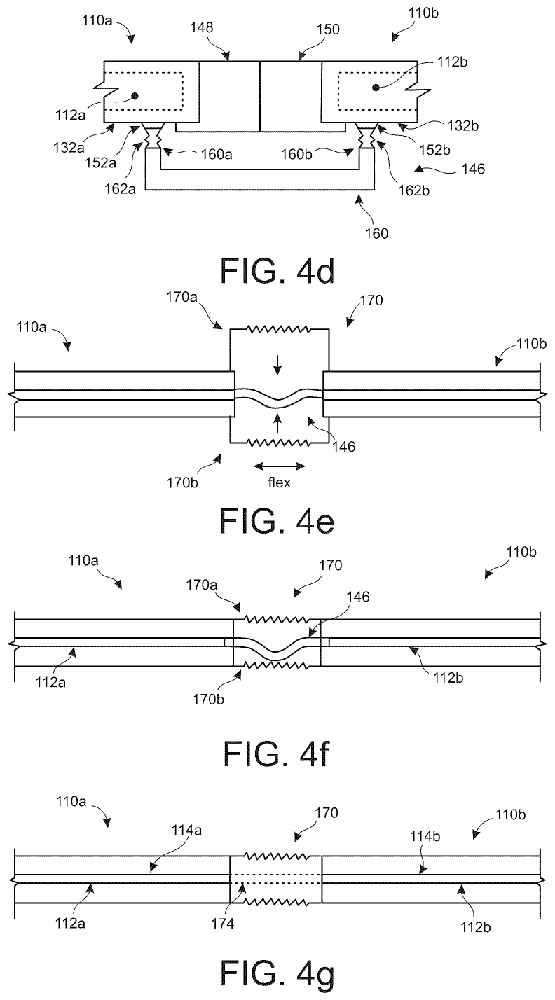

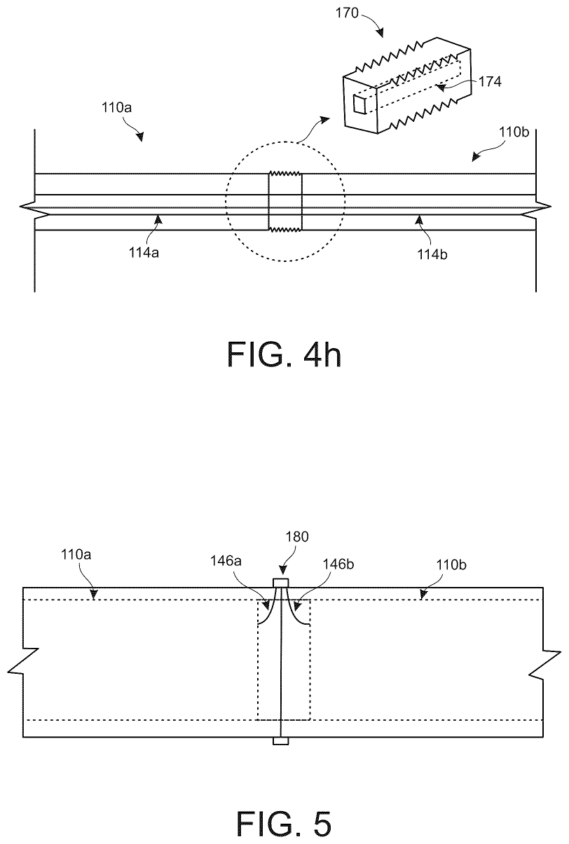

FIG. 4a is a diagram illustrating a partial view of a coupling system between two dock charging panels in an EV charging dock system, according to examples of the present disclosure. First charging panel 110a is electrically coupled to second charging panel 110b. In one example, first charging panel 110a is electrical coupled to second charging panel 110b using charging jumper 146. Charging jumper 146 is a flexible cable that is electrically coupled between charging device 112a and charging device 112b.

In one example, charging device 112a and charging device 112b are both wireway devices, and jumper 146 extends the wireway between two separate charging panels. In another example, charging device 112a and charging device 112b are both battery packs, and jumper 146 electrically couples the battery packs together. In another example, charging device 112a and charging device 112b are different devices (e.g., a wireway and a battery pack) or other devices and jumper 146 aids in electrically coupling devices from different charging panels together.

In one example, first charging panel 110a is located in a first dock frame area. Second charging panel 110b is located in a second dock frame area. Jumper 146 provides an electrical and/or control connection between charging devices located in different dock frame areas. In one example illustrated, jumper 146 makes an electrical connection at a common interface between two adjacent charging panels 110a, 110b.

FIG. 4b is a diagram illustrating a partial view of a coupling system between two dock charging panels in an EV charging dock system, according to examples of the present disclosure. In this example, charging panel 110a and charging panel 110b are illustrated. Charging panel 110a and charging panel 110b are located in separate adjacent dock frame sections. Jumper 146 electrically couples charging panel 110a to charging panel 110b cross an interface area between separate adjacent dock frame sections.

First dock frame section 148 is mechanically coupled to second dock frame section 150 at interface 152. Charging panel 110a is positioned within the first dock frame section 148. Charging panel 110b is positioned within the second dock frame section 150.

Charging panel 110a includes a panel body 132a. Panel extension 144a extends from a bottom side of the panel body 132a. A battery pack or other charging device 112a is positioned within charging panel 110a and panel extension 144a. Panel extension 144a further includes a quick connect port 152a for electrically coupling to the charging device 112a.

Charging panel 110b includes a panel body 132b. Panel extension 144b extends from the bottom side of the panel body 132b. A battery pack or other charging device 112b is positioned within the charging panel 110b and panel extension 144b. Panel extension 144b further includes a quick connect port 152b for electrically coupling to the charging device 112b.

Jumper 146 is made of a length of flexible cable having a waterproof jacket. The jumper 146 includes a first end 146a and a second end 146b. A first coupling device 154a is positioned at first end 146a. A second coupling device 154b is positioned at a second end 146b. In operation, jumper 146 is electrically coupled between charging panel 110a and charging panel 110b by quick coupling first coupling device 154a into quick connect port 152a, and quick coupling second coupling device 154b into quick connect port 152b.

FIG. 4c is a diagram illustrating a partial view of a coupling system between two dock charging panels in an EV charging dock system, according to examples of the present disclosure. In this example, quick connect port 152a is positioned into panel body 132a. Quick connect port 152b is positioned into panel body 132b. Charging panel 110a charging devices 112a are electrically coupled to charging panel 110b charging devices 112b by inserting/quick coupling first coupling device 154a into quick connect port 152a at panel body 132a, and quick coupling second coupling device 154b into quick connect port 152b located at panel body 132b.

FIG. 4d is a diagram illustrating a partial view of an alternative coupling system between two dock charging panels in an EV charging dock system, according to examples of the present disclosure. In this example, jumper 146 is made up of a U-shaped charging jumper 160 including a first end 160a and a second end 160b. A first flex member 162a is positioned at first end 160a. A second flex member 162b is positioned at the second end 160b. The charging panel 110a is electrically coupled to the charging panel 110b by connecting the first flex member 162a to charging panel 110a, and by connecting the second flex member 162b to charging panel 110b.

FIG. 4e is a diagram illustrating a partial view of a coupling system between two dock charging panels in an EV charging dock system, according to examples of the present disclosure. In this example, a flex member 170 is used as a transition member to mechanically couple charging panel 110a to charging panel 110b. The flex member 170 allows charging panel 110a to move relative to charging panel 110b, while staying mechanically coupled together. One application for using flex member 170 if for coupling two charging panels of a floating dock together.

In operation, jumper 146 is used to electrically couple charging panel 110a to charging panel 110b. Flex member 170 includes top piece 170a and bottom piece 170b. Top piece 170a and bottom piece 170b are snap fit into place to form flex member 170.

FIG. 4f is a diagram illustrating a partial view of a coupling system between two dock charging panels in an EV charging dock system, according to examples of the present disclosure. In FIG. 4f top piece 170a and bottom piece 170b are snap fit into position to form flex member 170. Flex member 170 allows charging panel 110a to move relative to charging panel 110b in a range of motion both vertically and horizontally. The range of motion of flex member 170 is less than the flex range of motion of jumper 146.

FIG. 4g is a diagram illustrating a partial view of a coupling system between two dock charging panels in an EV charging dock system, according to examples of the present disclosure. In this example, flex member 170c is a solid, flexible unit coupling charging panel 110a to charging panel 110b. The flex member 170 includes wireway channel 174 that connects wireway 114a operationally to wireway 114b. As illustrated in FIG. 4h, once flex member 170 is in position a continuous wireway exists between charging panel 110a and charging panel 110b.

FIG. 5 is a diagram illustrating a partial view of a coupling system between two dock charging panels in an EV charging dock system, according to examples of the present disclosure. Two charging jumpers are used to electrically connect charging panel 110a to charging panel 110b. An electrical connection box 180 is located on dock frame 126. First jumper 146a electrically couples first charging panel 110a to electrical connection box 180. Second jumper 146b electrically couples second charging panel 110b to electrical connection box 180, thereby completing the electrical connection between charging panel 110a and charging panel 110b.

As such, charging panels 110a, 110b can be directly electrically coupled together or can be electrically coupled together using intermediate dock coupling devices.

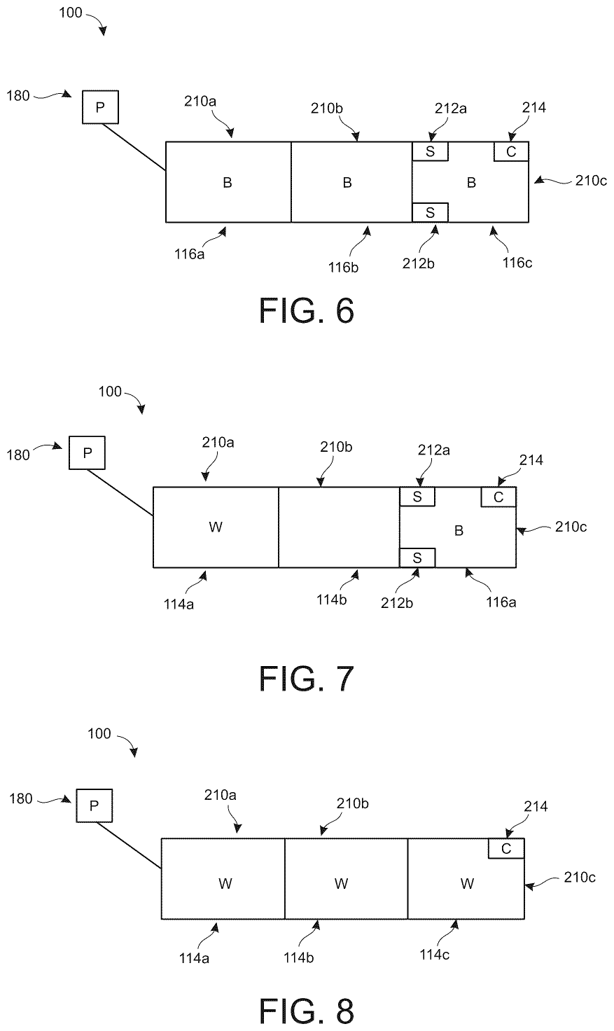

FIG. 6 is a block diagram illustrating one example configuration of an EV charging dock system, according to examples of the present disclosure. Dock charging panels can be configured to fit different needs and locations of the dock. If more battery power is needed due to the availability of electricity, charging panels with battery packs can be used. If only charging power is needed, charging panels with integral wireways can be used to get the charging power to the charging hub located on the dock for on the water charging of an electric vehicle.

In one example illustrated, a master charging station or charging power feed 180 is located near the charging dock system 100. The master charging station 180 electrically coupled to the charging dock system 100. The charging dock system 100 includes a first charging panel 210a, a second charging panel 210b, and a third charging panel 210c, and can be similar to the charging panels previously detailed herein. In this illustration, first charging panel 210a includes a battery pack 116a. Second charging panel 210b includes a battery pack 116b. Third charging panel 210c also includes an integral battery pack 116c. Additionally, dock sensors 212a and 212b are located on the charging panel 210c. Third charging panel 210c also includes a charging hub 214 that is in communication with and electrically coupled to master charging station 180, battery pack 116a, battery pack 116b, battery pack 116c, and sensors 212a, 212b.

FIG. 7 is a diagram illustrating one example configuration of an EV charging dock system, according to examples of the present disclosure. A master charging station or charging power feed 180 is located near the charging dock system 100. The master charging station 180 electrically coupled to the charging dock system 100. The charging dock system 100 includes a first charging panel 210a, a second charging panel 210b, and a third charging panel 210c, and can be similar to the charging panels previously detailed herein. In this illustration, first charging panel 210a includes an integral wireway 114a. Second charging panel 210b includes an integral wireway 114b. Third charging panel 210c includes an integral battery pack 116a. Additionally, dock sensors 212a and 212b are located on the charging panel 210c. Third charging panel 210c also includes a charging hub 214 that is in communication with and electrically coupled to master charging station 180, wireway 114a, wireway 114b, battery pack 116a, and sensors 212a, 212b.

FIG. 8 is a diagram illustrating one example configuration of an EV charging dock system, according to examples of the present disclosure. A master charging station or charging power feed 180 is located near the charging dock system 100. The master charging station 180 electrically coupled to the charging dock system 100. The charging dock system 100 includes a first charging panel 210a, a second charging panel 210b, and a third charging panel 210c, and can be similar to the charging panels previously detailed herein. In this illustration, first charging panel 210a includes an integral wireway 114a. Second charging panel 210b includes an integral wireway 114b. Third charging panel 210c includes an integral wireway 114c. Third charging panel 210c also includes a charging hub 214 that is in communication with and electrically coupled to master charging station 180, wireway 114a, wireway 114b and wireway 114c.

The charging panels are interchangeable, allowing the charging dock system to be configured based on the needs of a user. If more on the water battery power is needed, every charging panel can include a battery pack and act as an on the water power storage system. If only charging power is needed at the charging hub, the charging panels can act as a wireway system to provide power and a communications link to the charging hub.

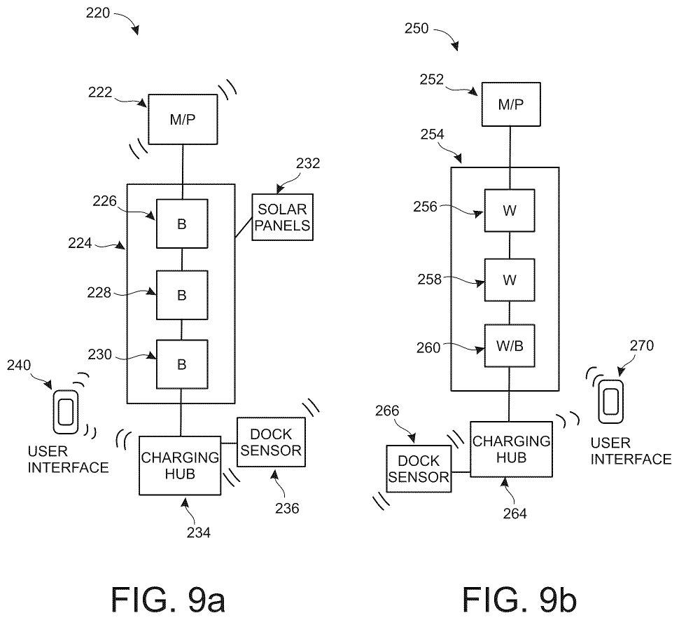

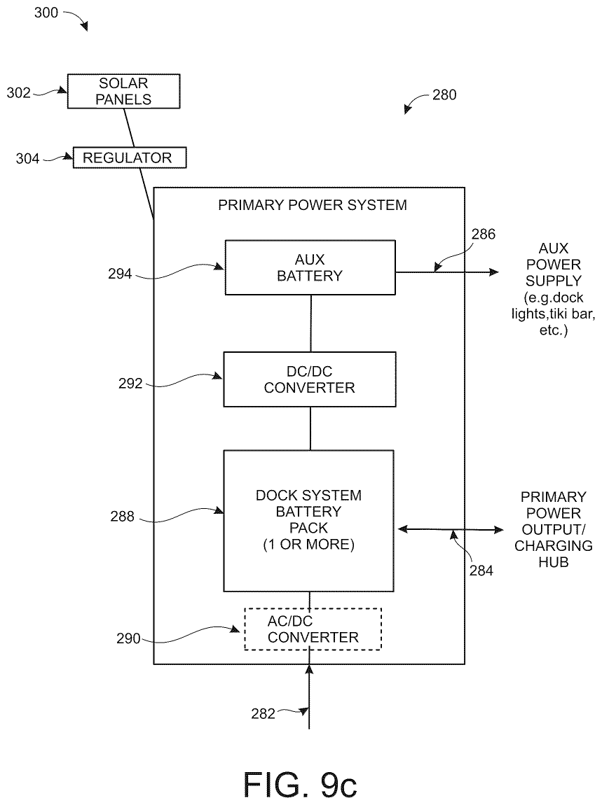

FIG. 9a is a block diagram illustrating an EV charging dock system, according to examples of the present disclosure. Master charging station/master power supply 222 is coupled to charging dock system 224. Charging dock system 224 can be similar to the charging dock systems detailed herein. In one example, charging dock system 224 includes a first battery pack 226, a second battery pack 228, and a third battery pack 230. Each battery pack 226, 228, 230 are located integral a charging panel located on the charging dock. Solar panels 232 are electrically coupled to charging dock system 224, and in particular battery packs 226, 228 and 230 for passive charging of the battery packs. The solar panels 232 can act as additional secondary charging devices for battery packs 226, 228 and 230, or be the primary charging devices for battery packs 226, 228 and 230.

Charging dock system 224 is coupled to charging hub 234. Charging hub 234 is also located on the same charging dock as charging dock system 224. Additionally, one or more dock sensors are in communication with charging hub 234 and/or master charging station 222. The dock sensors 236 can be in wired communication with charging hub 234 or wireless communication with charging hub 234.

One or more user interface devices 240 can be used for communicating with the charging dock system, including the master charging station 222 and/or charging hub 234. In one or more examples, user charging preferences are set up via user interface 240 for charging an electric watercraft or for using a charging dock as a power station for other electric devices. User interface 240 is a smart device, and for example, can include a smart phone, tablet, computer, watercraft control panel or other smart device.

FIG. 9b is a block diagram illustrating an EV charging dock system, according to examples of the present disclosure. Master charging station/master power supply 252 is coupled to charging dock system 254. Charging dock system 254 can be similar to the charging dock systems detailed herein. In one example, charging dock system 254 includes a first wireway 256, a second wireway 258, and a third wireway or battery pack 260. In operation, each device 256, 258, 260 are located as part of a charging panel located on the charging dock.

Charging dock system 254 is coupled to charging hub 264. Charging hub 264 is also located on the same charging dock as charging dock system 254. Additionally, one or more dock sensors 266 are in communication with charging hub 264 and/or master charging station 252. The dock sensors 266 can be in wired communication with charging hub 264 or wireless communication with charging hub 264.

One or more user interface devices 270 can be used for communicating with the charging dock system, including the master charging station 252 and/or charging hub 264. In one or more examples, user charging preferences are set up via user interface 270 for charging an electric watercraft or for using the charging dock as a power station for other electric devices. User interface 270 is a smart device, and for example, can include a smart phone, tablet, computer, watercraft control panel or other smart device.

FIG. 9c is a block diagram illustrating a primary power system 280 for an EV charging dock system, according to examples of the present disclosure. The primary power system 280 is an on-the-water power system, being located on a users dock as part of the charging dock system. The primary power system is located on the charging dock system. In one example, the primary power system 280 includes power input from a utility power feed, residential power feed, power transformer, master charging station or other power device, indicated at 282. The primary power system provides a primary power output 284 at the dock system charging hub, for charging an electric watercraft. Additionally, the primary power system 280 can include an auxiliary power output 286 that provides power to other dock system electrical devices (e.g., dock lights, tiki bar, cleaning systems, etc.). The auxiliary power output 286 is at a reduced voltage (e.g., 240 volts or 120 volts) than the charging dock system primary power output voltage (e.g., 400 VDC, 600 VDC, or 800 VDC).

In one example, the primary power system 280 includes a dock system battery pack (e.g., one or more) 288. The dock system battery pack 288 receives a power feed 282 for charging batteries located in the battery pack 288. In one example, a power converter 290 (e.g., an AC/DC or AC/AC or DC/DC power converter) is positioned between the input power feed 282 and the dock system battery pack 288. The primary power output 284 is output via the cock system battery pack 288. Alternatively, the primary power output could be a direct power feed from the power input 282.

The primary power system 280 can include a DC/DC converter 292 coupled to an auxiliary battery 294. The auxiliary battery 294 provides an auxiliary power supply to auxiliary electric dock devices.

The charging dock system can also include a solar power system 300. The solar power system 300 provides a solar power input to primary power system 280. In one example, the solar power system 300 includes one or more solar panels 302 coupled to a voltage regulator 304 for providing a regulated voltage to the primary power system 280. The solar power system can provide a power input for charging the auxiliary battery 294 and/or the dock system, battery pack 288.

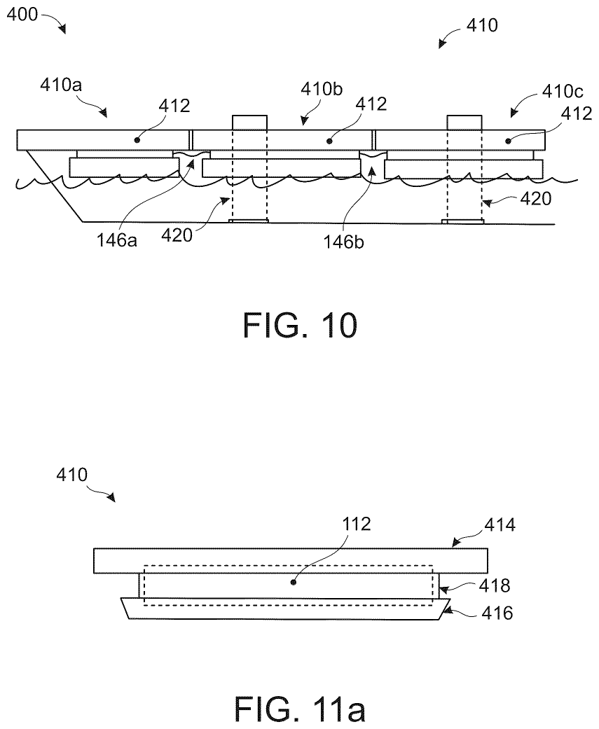

FIG. 10 is a diagram illustrating an EV charging dock system 400, where the EV charging system is a floating dock charging system, according to examples of the present disclosure. The charging dock system 400 includes one or more floating dock units 410 which can be similar in function to the charging panels 110 previously detailed herein. As illustrated, charging dock system 400 includes floating dock unit 410a, floating dock unit 410b, and floating dock unit 410c. Each floating dock unit 410 (i.e., 410a, 410b, 410c can include one or more charging devices 412 (e.g., a battery pack or charging wireway). Flexible jumpers can electrically couple floating dock units together. In one example, jumper 146a electrically couples floating dock unit 410a to floating dock unit 410b, and jumper 146b electrically couples floating dock unit 410b to floating dock unit 410c. Other floating dock support members 420 may aid in supporting charging dock system 400 when positioned on the water.

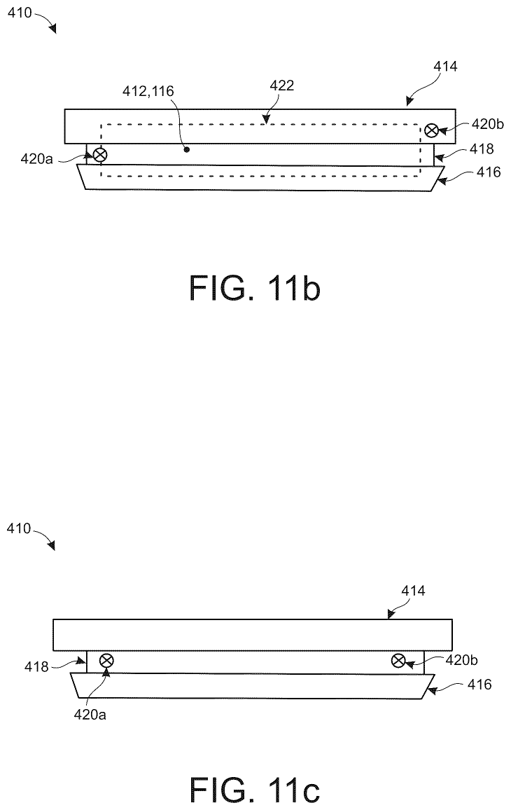

FIG. 11a is a diagram illustrating a charging dock unit for use with an EV charging dock system, according to examples of the present disclosure. In one example, charging dock unit 410 includes a charging panel 414 and a float member 416. A transition unit 418 operates to transition between the charging panel 414 and the float member 416. Charging device 112 is located within the float dock unit 410, and may comprise one or more charging devices as detailed herein (e.g., a battery pack, a wireway, etc.). The charging device 112 may be located (e.g., in a cavity or contained within) the charging panel 414, the float member 416, and the transition unit 418. In another example, the charging device 112 is located entirely within the charging panel 414. In another example, the charging member is entirely located within the float member 416 or the transition member 418.

FIG. 11b is a diagram illustrating a charging dock unit for use with an EV charging dock system, according to examples of the present disclosure. Charging dock unit 410 includes a battery pack positioned within or integral the charging dock unit 410. In one example illustrated, the battery pack 116 is located within a battery pack cavity 422 that extends between the charging panel 414, the float member 416, and the transition unit 418. One or more charging wireways are located within the charging floating dock unit 410. In one example, charging wireway 420a is formed integral transition unit 418, and communicates with battery pack cavity 422. Wireway 420b is located in charging panel 414.

FIG. 11c is a diagram illustrating a charging dock unit for use with an EV charging dock system, according to examples of the present disclosure. The charging dock unit 410 includes a first charging wireway 420a located in transition member 418. A second charging wireway 420b is located in transition member 418 on a side of the floating dock unit 410 opposite the first charging wireway 420a. Alternatively, the charging wireways can be located partially or entirely within charging panel 414 or float member 416.

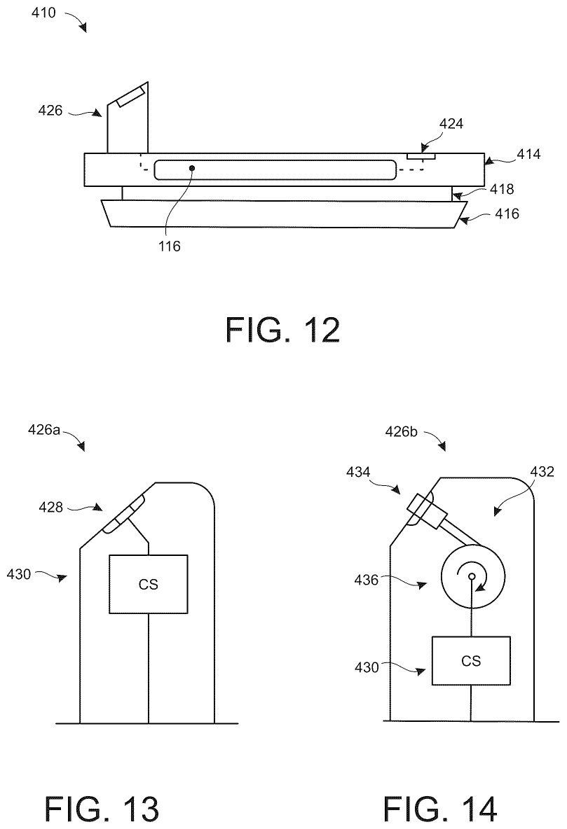

FIG. 12 is a diagram illustrating a charging dock unit for use with an EV charging dock system, according to examples of the present disclosure. The charging dock unit includes a sensor 424 and charging hub 426 coupled to a surface of charging panel 414. In one or more examples, sensor 424 is similar to sensors previously detailed herein. Charging hub 426 can be similar to charging hubs previously detailed herein.

FIG. 13 is a diagram illustrating a charging hub for use with an EV charging dock system, according to examples of the present disclosure. Charging hub 426a is part of charging dock system 400 and is positioned on the surface of a dock charging unit 410. In one example, the charging hub 426a includes a smart charging control system 430 coupled to a charging port 428. A charging cable extends from the charging port. The charging cable plugs into the charging port of a watercraft requesting a charge. In one example, a charging cable includes a first plug for plugging into an electric watercraft and a second plug at an opposite end for plugging into the charging port 428. The charging port 428 can be a mechanical charging port, a magnetic charging port, or an electromagnetic charging port.

FIG. 14 is a diagram illustrating a charging hub for use with an EV charging dock system, according to examples of the present disclosure. Charging hub 426b is part of charging dock system 400 and is positioned on the surface of a dock charging unit 410. In one example, the charging hub 426a includes a smart charging control system 430 coupled to a charging port 432. The charging port 432 includes a charging cable 434 with take-up reel 436. When an electric watercraft needs a charge the charging cable can be pulled from the charging hub 426b and plugged into the charging port of the electric watercraft requesting a charge. When charging is finished, the charging cable is unplugged from the electric watercraft and returned to the charging hub 426b via the take-up reel 436. In one or more examples, take-up reel 436 is an automatic take-up reel.

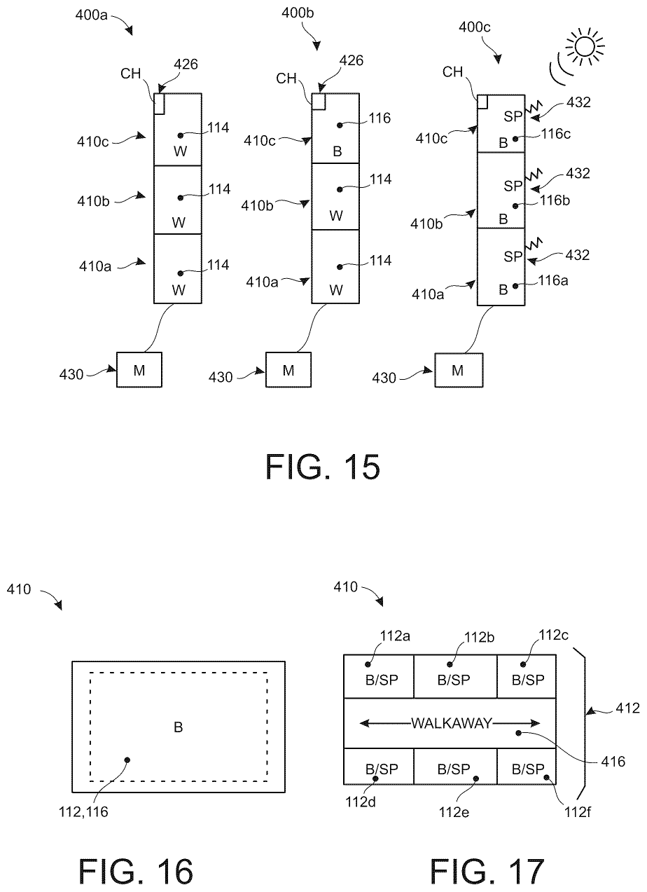

FIG. 15 is a diagram illustrating dock charging system configurations for use with an EV charging dock system, according to examples of the present disclosure. Floating charging dock system 400a includes floating dock unit 410a, floating dock unit 410b and floating dock unit 410c. The floating dock unit 410a includes a charging device that is a charging wireway 114. The floating dock unit 410b includes a charging device that is a charging wireway 114. Floating dock unit 410c includes a charging device that is a charging wireway 114. Floating dock unit 410c includes charging hub 426. Master charging station 430 is coupled to the floating dock charging system 400a.

Floating charging dock system 400b includes floating dock unit 410a, floating dock unit 410b and floating dock unit 410c. The floating dock unit 410a includes a charging device that is a charging wireway 114. The floating dock unit 410b includes a charging device that is a charging wireway 114. Floating dock unit 410c includes a charging device that is a battery pack 116. Floating dock unit 410c includes charging hub 426. Master charging station 430 is coupled to the floating dock charging system 400b.

Floating charging dock system 400ac includes floating dock unit 410a, floating dock unit 410b and floating dock unit 410c. The floating dock unit 410a includes a charging device that includes a battery pack 116a. The floating dock unit 410b includes a charging device that includes a battery pack 116b. Floating dock unit 410c includes a charging device that is a battery pack 116c. Additionally, each floating dock unit 410a, 410b, 410c includes one or more surface mounted solar panels 432 coupled to their respective battery pack 116a, 116b, 116c for using solar power to aid in charging the battery packs. Floating dock unit 410c includes charging hub 426. Master charging station 430 is coupled to the floating dock charging system 400a.

FIG. 16 is a diagram illustrating dock charging system configurations for use with an EV charging dock system, according to examples of the present disclosure. Floating dock unit 410 includes a charging device 112 that is a battery pack 116. In one example, the battery pack 116 is a rectangular shaped panel battery that is located within the charging panel of the floating dock unit 410. The surface area of the battery pack is a little smaller than the surface area of the charging panel, as indicated by the dashed line.

FIG. 17 is a diagram illustrating dock charging system configurations for use with an EV charging dock system, according to examples of the present disclosure. Floating dock unit 410 includes a charging device 112 that is made up of multiple batteries or battery packs (e.g., six illustrated) located along the outer side edges of the floating dock unit 410, within the charging panel 412. The charging devices 112a,b,c,d,e,f each include a solar panel located directly above the corresponding battery pack, on the top surface 414 of the floating dock unit 410. A walkway area 416 is provided through the middle of the top surface of the floating dock unit 410. The solar panels provide for solar charging of the respective battery located in the charging panel 412 area below.

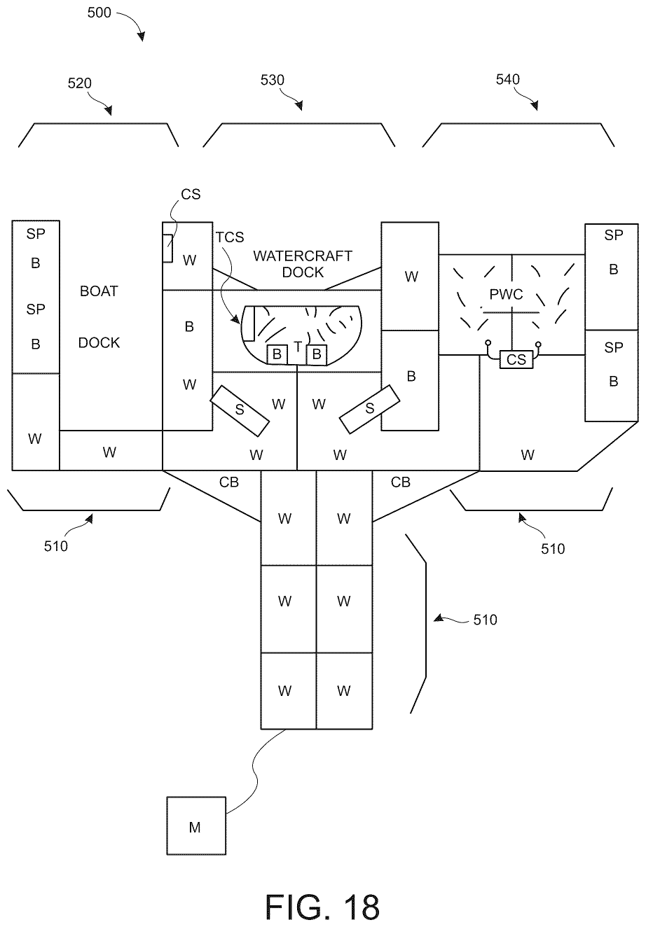

FIG. 18 is a diagram illustrating an on the water power station, including an EV charging dock system, according to examples of the present disclosure. The water power station 500 includes one or more charging dock systems as detailed herein, suitable for charging different types of electric watercraft. The charging power station 500 can either be a suspended charging dock system, or a floating charging dock system. All of the charging dock system units that make up the power station 500 can be similar to those detailed herein. The power station 500 is an on-the-water power station

Charging power station 500 includes a number of pieces that when put together make up the power station. As illustrated, a dock unit labels are as follows: B—charging panel with a battery or battery pack; W—charging panel with a charging wireway; SP—solar panel positioned on the charging panel; CS—charging station or charging hub; TCS—tiki bar charging station; CB—corner battery; M—master control/charging station or main power feed to the charging power station.

Powerstation 500 is made up of multiple charging areas, and also includes an on the water bar area. In one example, the power station 500 includes a walkway areas 510. The walkway area 510 provides access to the other areas of power station 500. Functionally, the walkway area 510 primarily made up of charging panels that are wireway charging panels for transmitting charging power from the master charging station M to the rest of the power station 500.

Area 520 is configured as an electric watercraft charging area and is configured as a protected area for a boat to dock. Area 520 is formed by battery charging panels B and wireway charging panels W. Solar panels are also provided for solar charging of one or more of the battery charging panels. A charging station CS is located along a side of the watercraft charging area.

An electric watercraft can “park” within area 520, and receive a charge via charging station CS. Boaters can visit other areas of the powerstation 500 while charging their electric watercraft.

Area 530 is configured as an electric watercraft charging area and is also configured as an area for watercraft to drop off users of the powerstation 500. For example, area 530 includes an on the water bar area T (e.g., a tiki bar), sitting areas, and other areas. Charging station TCS (tiki bar charging station) is located within area 530.

Area 540 is configured as a personal watercraft charging area (labeled PWC). Personal watercraft can be docked on the floating dock area, and can also be charged using on-the-water charging station CS. The charging panels surrounding the PWC area include wireway charging panels and battery charging panels B. Solar panels SP are also provided on the surface of some of the charging panels for solar charging of the battery charging panels.

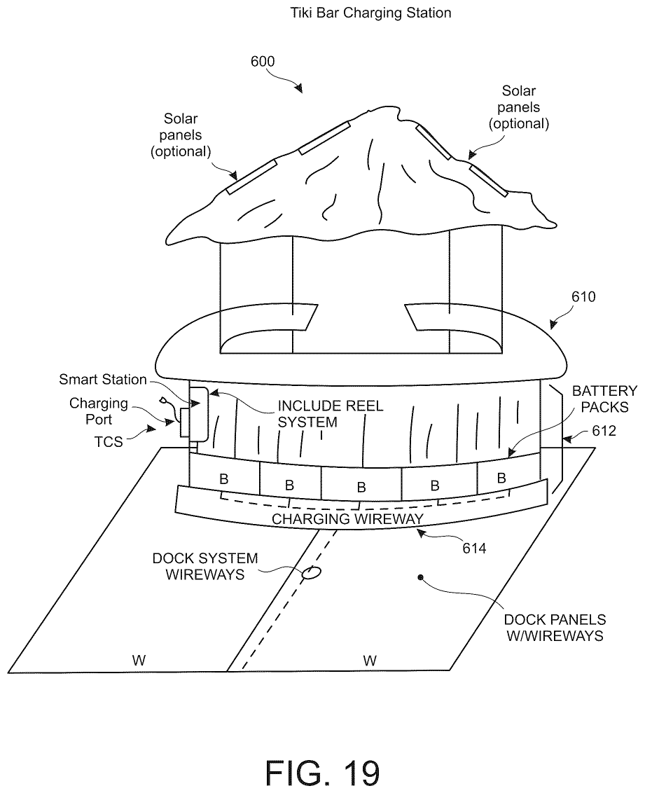

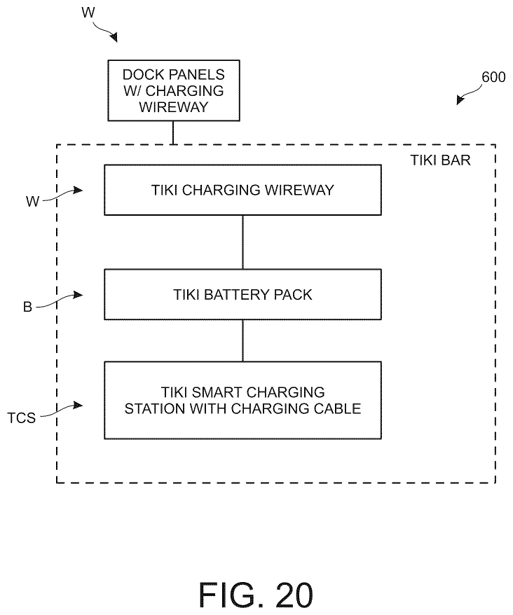

FIG. 19 is a diagram illustrating an on the water power station configured as a bar and suitable for use with an EV charging dock system, according to examples of the present disclosure. In one example, the bar is configured as a tiki bar illustrated generally at 600. The bar 600 includes a general bar area 610 with a bar sidewall 612. Hidden within bar sidewall 610 is a charging wireway 614 coupled to dock panel wireway charging panels W. The charging wireway provides charging power to bar charging station TCS and battery packs B that are also hidden within the bar sidewall 610. The bar charging station TCS (e.g., tiki charging station) is a smart charging station as detailed herein, and includes a charging device (e.g., a charging cable with charging plug) for on the water charging of electric watercraft that pull up to the bar 600. The smart charging station may include a reel system for the charging cable. In one or more examples, the barr 600 includes solar panels on the bar roof. The solar panels are coupled to the batteries B for solar charging of the batteries within the battery power system. In one example, solar panels are located on the water side of bar 600. FIG. 20 is a block diagram illustrating one example of the power station 600 of FIG. 19.

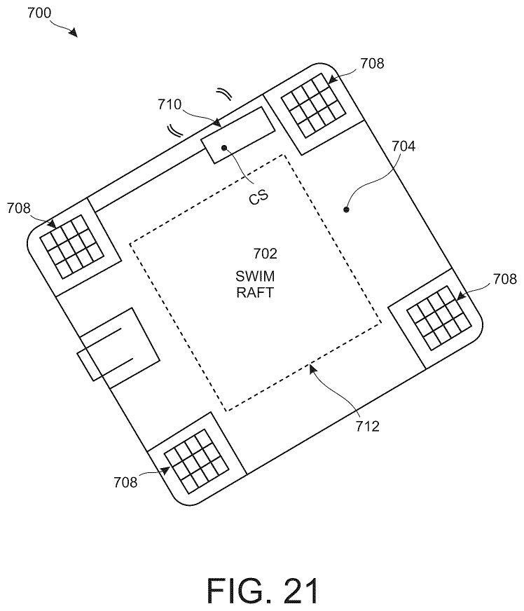

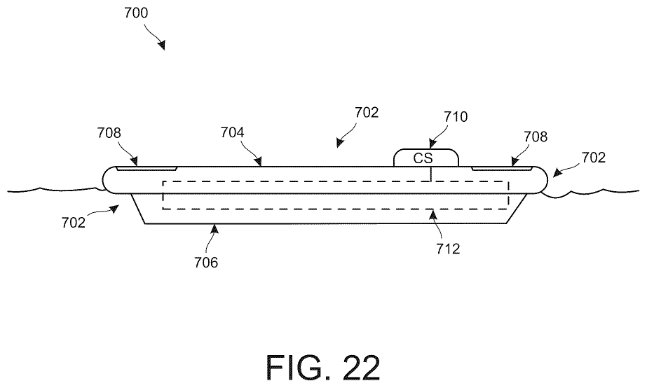

FIG. 21 is a diagram illustrating an on the water power station 700 configured as a swim raft, suitable for use as an EV charging system, according to examples of the present disclosure. FIG. 22 is a diagram illustrating a side view of the on the water power station 700 configured as a swim raft of FIG. 21, according to examples of the present disclosure. It is recognized that the power station 700 is a floating power station, and may take on shapes and sizes other than that of a swim raft.

Power station 700 includes a raft body 702 having a top surface 704 and a bottom surface 706. One or more solar panels 708 are attached to the top surface. Additionally, a charging station 710 is positioned on the top surface 704. In one example, the charging station 710 is a low profile charging station and watertight. Battery pack 712 is positioned within the raft body 702, and is electrically coupled to the charging station 710 and charging solar panels 708. In one example, when the power station 700 is positioned in the water, the battery pack 712 is at least partially located below the surface of the water. Locating the battery pack at least partially below the surface of the water aids in cooling the battery pack during a charging operation.

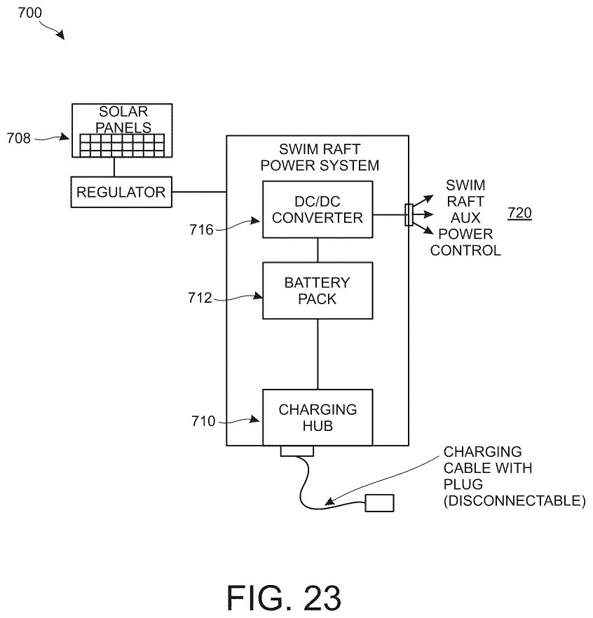

FIG. 23 is a block diagram illustrating an on the water power station configured as a swim raft, according to examples of the present disclosure. The water power system may further include a DC/DC converter 716 to provide and auxiliary power output 720 (e.g., at an outlet box on the power station) to auxiliary devices associated with the power system. For example, power may be needed at the swim raft power station to blow up inflatable swim tubes, etc.

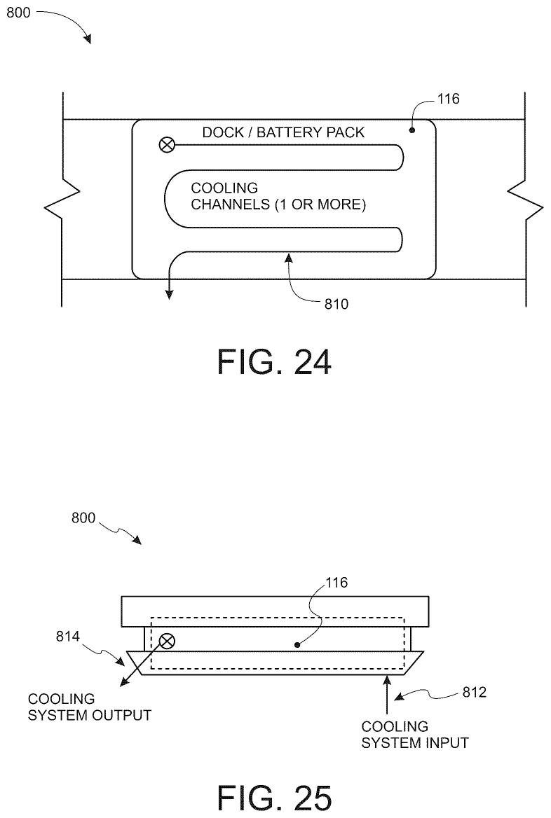

FIG. 24 is a diagram illustrating an EV charging dock system including a cooling system generally at 800, according to examples of the present disclosure. FIG. 25 is a diagram illustrating a side view of an EV charging dock system including a cooling system 800, according to examples of the present disclosure. In one example, battery pack 116 is located within dock system 800. The battery pack 116 includes one or more cooling channels 810. Cooling system fluids (e.g., cooling water from below the dock) are input to the battery pack at 812, routed through the battery pack 116 via cooling channels 810 to cool the battery pack, and exits the battery pack at cooling system output 814.

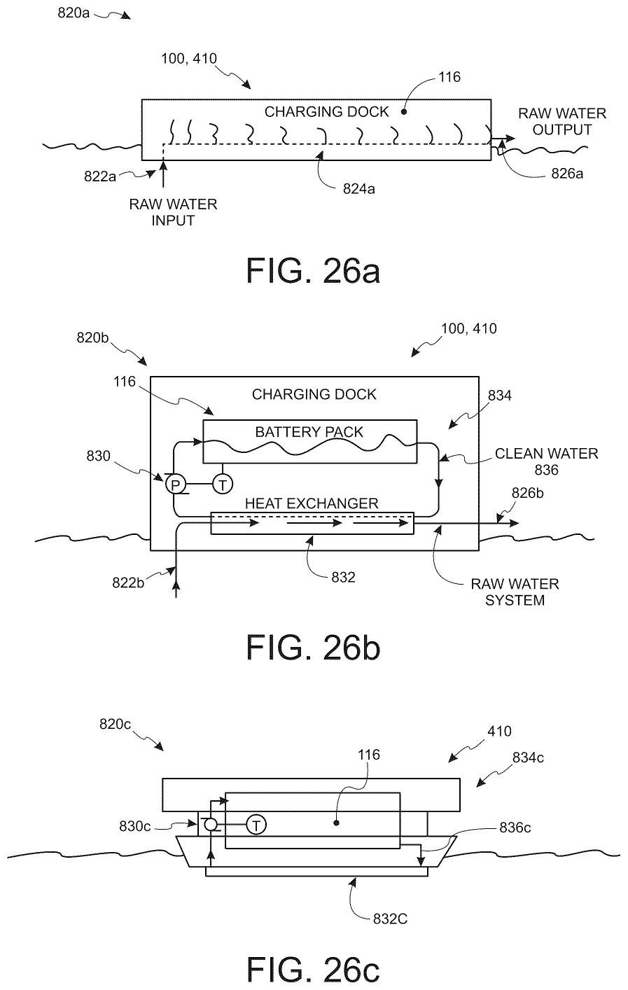

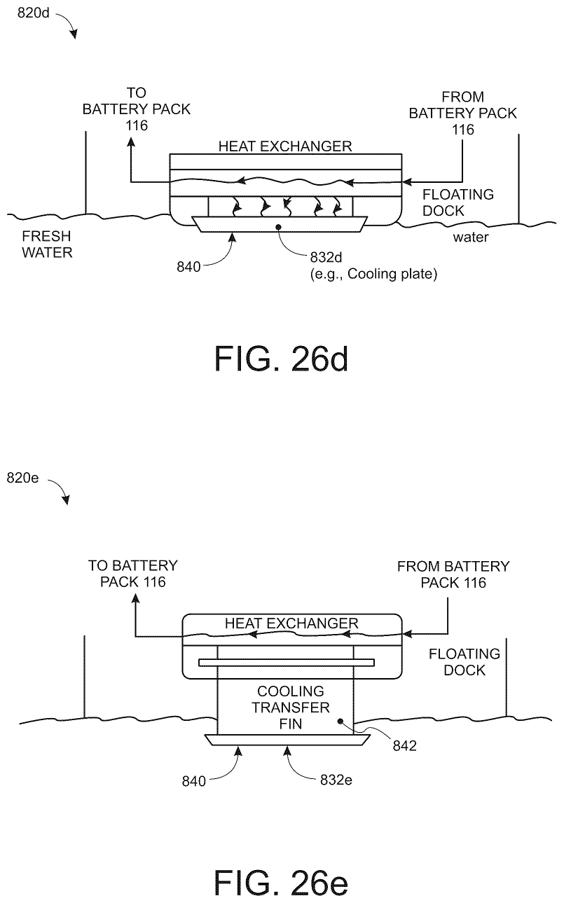

FIG. 26a is a diagram illustrating an EV charging dock cooling system generally at 820a, according to examples of the present disclosure. The cooling system 820a is a raw water cooling system. A battery pack 116 is positioned within the charging dock 100,410. Raw water is input to the battery pack at 822a, routed through the battery pack at 824a, and output from the battery pack at 826a. The raw water operates to cool the battery pack 116 during battery operation.

FIG. 26b is a diagram illustrating an EV charging dock cooling system generally at 820b, according to examples of the present disclosure. The cooling system 820 is a combination raw water/closed loop cooling system that utilizes a heat exchanger with clean water. System 820b includes a pumping system 830 and a heat exchanger 832. Raw water is input at 822b, routed through heat exchanger 832, and output at 826b. A closed loop clean water system 834 routes clean water 836 through pump 830, through battery pack 116, and through heat exchanger 832. In operation, upon sensing at temperature sensor T an elevated temperature of battery pack 116, water is pumped through the closed loop cooling system 834 to aid in cooling the battery pack 116. Raw water is separately moved through heat exchanger 832 to cool the clean water as it moves through the heat exchanger 832.

FIG. 26c is a diagram illustrating an EV charging dock cooling system generally at 820c, according to examples of the present disclosure. The cooling system 820c is an entirely closed loop system that uses clean water only, illustrated at 834c. Heat exchange occurs at the raw water between the clean water and the raw water. In one example, a heat exchanger 832c is positioned at the raw water. In one example, the heat exchanger is a simple metal plate (e.g., stainless steel or aluminum).

FIG. 26d is a diagram illustrating an EV charging dock cooling system generally at 820d, according to examples of the present disclosure. FIG. 26e is a diagram illustrating an EV charging dock cooling system generally at 820e, according to examples of the present disclosure. Both cooling systems 820d and 820e utilize raw freshwater to cool a battery pack 116. The cooling systems 820d and 820e each include devices in direct contact with the fresh raw water for heat transfer. In one or more examples, the heat transfer devices include a metal plate 840 and or a cooling transfer fin 842.

It is recognized that the charging dock system of the present disclosure can be configured for use in many charging system applications, including those not disclosed herein.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

The claims are part of the specification.

1-4. (canceled)

5. A charging dock system including a charging panel comprising:
a panel body including a top side and a bottom side; and
a charging device at least partially integrated into the panel body.

6. The charging dock system of claim 5 where the panel body is generally rectangular shaped and is made of a molded material.

7. The charging dock system of claim 5, where the charging device extends from the bottom side of the panel body.

8. The charging dock system of claim 7, comprising a panel extension that extends from the bottom side of the panel body, the panel extension including a first charging device comprising a wireway.

9. The charging dock system of claim 5, where the charging device includes a wireway.

10. The charging dock system of claim 9, where the wireway is a power and control wireway.

11. The charging dock system of claim 9, including a coupling device configured to electrically couple the wireway to a second charging device located outside the charging panel.

12. The charging dock system of claim 5, comprising:
a channel located on the top side, where the channel extends longitudinally along a center area of the panel body.

13. The charging dock system of claim 12, including one or more vias located along the channel that aid in removing water from the top side of the panel body.

14. The charging dock system of claim 5, comprising:
the charging device including a battery pack configured to power one or more electric devices.

15. The charging dock system of claim 5, where the battery pack is configured to aid in charging an electric watercraft.

16. The charging dock system of claim 5, comprising:
a sensor system coupled to the panel body, the sensor system including a motion detector.

17. The charging dock system of claim 5, comprising:
at least one solar panel on the top side of the panel body, configured to aid in charging a battery pack.

18. A dock system comprising:
a first dock panel comprising a first charging panel including one or more charging devices to aid in charging an electric vehicle;
a second dock panel positioned adjacent to the first dock panel, the second dock panel comprises a second charging panel including one or more charging devices; and
where the first dock panel is mechanically coupled to the second dock panel.

19. The dock system of claim 18, comprising a support structure that maintains the first dock panel in a fixed position relative to the second dock panel, where the first dock panel is mechanically coupled to the second dock panel via the support structure.

20. The dock system of claim 18, comprising:
where the first dock panel includes a charging wireway passing therethrough; and
where the first dock panel includes a battery pack comprising one or more panel batteries.

21. The dock system of claim 20, the battery pack being integrated into the first charging panel such that it is not viewable from a top side of the first charging panel.

22. A dock system configured as a power station comprising:
a support structure;
a first dock panel positioned in the support structure, comprising a first charging panel including one or more charging devices to aid in charging an electric vehicle;
a second dock panel positioned in the support structure and located adjacent to the first dock panel, the second dock panel including one or more charging devices; and
a charging jumper that electrically couples the first charging panel to the second charging panel.

23. The dock system of claim 22, the charging jumper comprising one or more flexible cables.

24. The dock system of claim 22, the charging jumper comprising a cable; and a quick disconnect for electrically coupling the cable to the first charging panel.

25. The dock system of claim 22, comprising where the first dock panel is a removable dock panel.

26. The dock system of claim 22, where the charging panel including a battery pack to aid in charging an electric watercraft.
